(19) United States
(12) Patent Application Publication
(10) Pub. No.: US 2014/0059549 A1
(43) Pub. Date: Feb. 27, 2014

(54) APPLICATION RECOGNITION SYSTEM AND METHOD

(71) Applicants: HON HAI PRECISION INDUSTRY CO., LTD., New Taipei (TW); FU TAI HUA INDUSTRY (Shenzhen) CO., LTD., Shenzhen (CN)

(72) Inventors: LING LI, Shenzhen (CN); SUO-BING SU, New Taipei (TW); CHIH-YUAN YANG, New Taipei (TW)

(21) Appl. No.: 13/930,440

(22) Filed: Jun. 28, 2013

(30) Foreign Application Priority Data
Aug. 27, 2012 (CN) 201210307887X

(51) Int. Cl. G06F 9/44

(52) U.S. Cl. CPC G06F 9/44
USPC 718/100

(57) ABSTRACT

The disclosure provides an application recognition system and an application recognition method for an electronic device. The method includes determining whether or not there is one or more hidden running applications, where the hidden applications are associated with an inactive window under an active window associated with the current running application on a screen of the electronic device. If there is one or more hidden running applications, the system acquires a sound control instruction associated with each of the hidden running applications and controls the sound output unit to output the preset sound every preset time period.

### BACKGROUND

1. Technical Field

The disclosure relates to an application recognition technology and, more particularly, to an application recognition system and an application recognition method adapted for an electronic device.

2. Description of Related Art

Many applications can be installed in an electronic device, but when multiple applications are running simultaneously, only one running application can be operated by a user, so the other running applications are often forgotten.

Therefore, what is needed is an application recognition system to overcome the described shortcomings

### BRIEF DESCRIPTION OF THE DRAWINGS

FIG. 1 is a block diagram of an electronic device including an application recognition system in accordance with an exemplary embodiment.

FIG. 2 is a block diagram of the application recognition system of the electronic device of FIG. 1.

FIG. 3 is a flowchart illustrating a method of recognizing applications adapted for the electronic device of FIG. 1.

### DETAILED DESCRIPTION

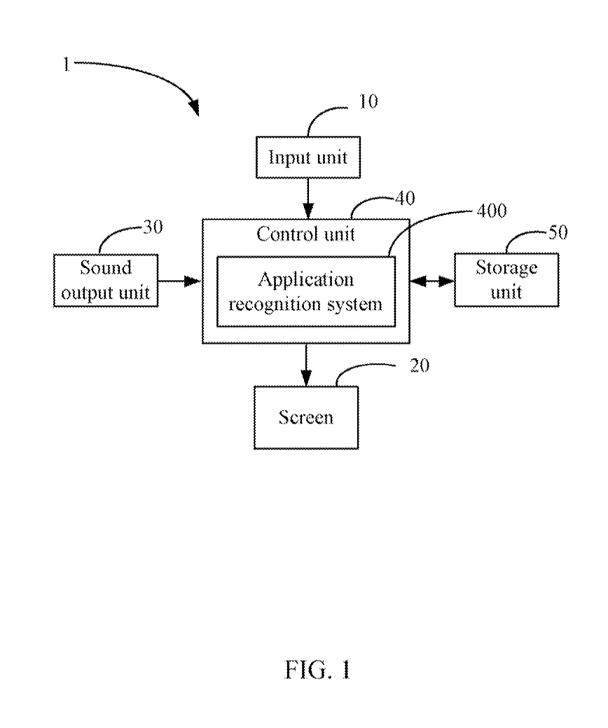

FIG. 1 is a block diagram of an electronic device including an application recognition system in accordance with an exemplary embodiment. The electronic device 1 may be a mobile phone, an electronic book, a media player, or the like. The electronic device 1 includes an input unit 10, a screen 20, a sound output unit 30, a control unit 40, and a storage unit 50.

The input unit 10 generates input signals in response to user input. For example, the electronic device 1 runs an application or performs an operation for the application in response to user input from the input unit 10. The screen 20 displays information, for example, a running interface of the application. The sound output unit 30 outputs sound. The sound output unit 30 may be a speaker or an earphone. The control unit 40 controls the electronic device 1 and performs the application recognition system 400.

The storage unit 50 stores a number of applications and relationships between the applications and their sound control instructions. For example, the storage unit 50 stores a number of game applications, an electronic map, and a number of study applications. Each sound control instruction is associated with a preset sound in the storage unit 50. For example, a first sound control instruction is associated with a first song, and a second sound control instruction is associated with a second song.

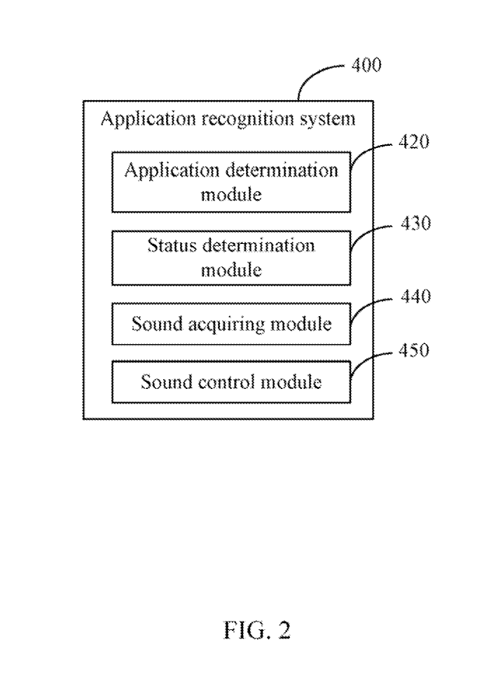

As shown in FIG. 2, the application recognition system 400 includes an application determination module 420, a status determination module 430, a sound acquiring module 440, and a sound control module 450, all of which are executed by the control unit 40.

The application determination module 420 determines whether or not at least one application is running in the electronic device 1. In general, when an application is selected and running, a corresponding window is opened. When there are a number of running applications, there are a number of opened windows in a state of activeness or inactiveness, determined by the tasks of the electronic device user. Among the opened windows, an active window is the current window in focus and at the top of all other windows on the screen, and an inactive window is an unfocused window under the active window.

When at least one application is running, the status determination module 430 determines whether or not there are one or more running applications hidden as inactive windows. The current running application in focus is associated with the active window. The hidden running applications are associated with the inactive windows. There is only one active window on the screen 20.

For example, the application determination module 420 determines that three applications are running in the electronic device 1, such as “A” application, “B” application, and “C” application. “A” application corresponds to a first preset song, “B” application corresponds to a second preset song, and “C” application corresponds to a third preset song. The status determination module 430 determines that the “A” running application is associated with the active window on the screen 20 and both the “B” running application and the “C” running application are associated with inactive windows.

If there are one or more hidden applications running while an application is in the active window, the sound acquiring module 440 acquires a sound control instruction associated with each of the hidden running applications from the storage unit 50. The sound control module 450 performs a sound control operation and controls the sound output unit 30 to output a preset sound every preset time period, thereby prompting the user not to forget the hidden running applications.

For example, both the “B” application and the “C” application are the hidden running applications, the sound control module 450 controls the sound output unit 30 to output the second and third preset songs every two preset time periods. When the sound output unit 30 is an earphone, the sound control module 450 controls the left channel of the earphone to output the second preset song every second preset time period and the right channel of the earphone to output the third preset song every third preset time period. The second preset time period is different from the third preset time period.

Furthermore, the status determination module 430 further determines whether or not one of the hidden running applications is the target of user input from the input unit 10 on the screen 20. If one of the hidden running applications is the target of user input from the input unit 10, it is determined that the hidden running application is associated with the current active window on the screen 20. The focused running application is switched from the previously active window to the previously inactive but targeted window and the hidden running application is switched from the inactive window to the active window. If none of the hidden applications is the target of user input from the input unit 10, it is determined that the hidden running applications are not operated by the user.

If one of the hidden running applications is the target of user input from the input unit 10, the sound control module 450 removes the sound control associated with that application, and the output unit 30 does not output a preset sound. If none of the hidden running applications is the target of user input from the input unit 10, it is determined that the current active window has not changed, and the electronic device 1 maintains the current sound controls. Therefore, the application recognition system 400 controls the sound output unit 30 to output different sounds corresponding to different hidden running applications.

For example, when “B” application is the target of user input from the input unit 10, both “A” and “C” applications are hidden, the sound control module 450 does not output the second preset song, and instead outputs the first and third preset songs every two preset time periods.

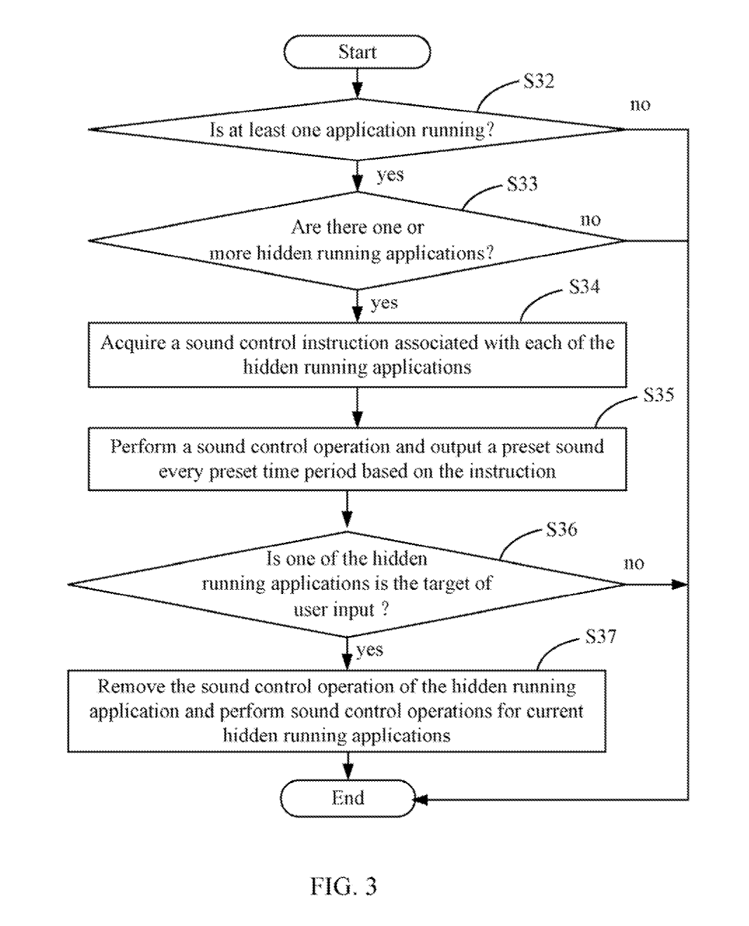

FIG. 3 is a flowchart illustrating a method of recognizing applications adapted for the electronic device of FIG. 1.

In step S32, the application determination module 420 determines whether or not at least one application is running.

In step S33, if at least one application is running, the status determination module 430 determines whether or not there are one or more hidden running applications. If there are no applications running, the procedure ends.

In step S34, if there are one or more hidden running applications, the sound acquiring module 440 acquires a sound control instruction associated with each of the hidden running applications from the storage unit 50. If there is none hidden application, it is determined that only one application is running, the procedure ends.

In step S35, the sound control module 450 performs a sound control operation and controls the sound output unit 30 to output a preset sound every preset time period based on the sound control instruction.

In step S36, the status determination module 430 further determines whether or not one of the hidden running applications is the target of user input from the input unit 10.

In step S37, if one of the hidden running applications is the target of user input from the input unit 10, the sound control module 450 removes the sound control operation of that application and performs sound control operations for the remaining hidden running applications and the previous application in the active window. If none of the hidden running applications is the target of user input from the input unit 10, the electronic device 1 maintains the current sound control operations and the procedure ends.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An application recognition system for an electronic device, wherein the electronic device comprises a sound output unit for outputting sound and stores a plurality of applications and relationships between the applications and sound control instructions, and each sound control instruction is associated with a preset sound, the application recognition system comprising:
an application determination module to determine whether or not at least one application is running in the electronic device;
a status determination module to determine whether or not there are one or more hidden running applications, wherein each of the hidden running applications is associated with an inactive window under a current active window in focus associated with a running application on a screen of the electronic device;
a sound acquiring module to acquire a sound control instruction associated with each of the hidden running applications when there are the one or more hidden running applications;
a sound control module to control the sound output unit to output the preset sound every preset time period based on the sound control instruction; and
wherein the application recognition system further comprises at least one processor to execute the modules of the application recognition system.

2. The application recognition system of claim 1, further comprising an input unit for generating input signals in response to user input, wherein when one of the at least one application receives an input signal from the input unit, the status determination module is further configured to determine that other applications are hidden.

3. The application recognition system of claim 1, wherein the sound output unit is an earphone, the sound control module is further configured to control the left channel of the earphone to output a first preset sound every first preset time period and the right channel of the earphone to output a second preset sound every second preset time period.

4. The application recognition system of claim 1, wherein the status determination module is further configured to determine whether or not one of the one or more hidden running applications is the target of user input from the input unit.

5. The application recognition system of claim 4, wherein when one of the one or more hidden running applications is the target of user input from the input unit, the sound control module is further configured to remove the sound control operation of that application and perform sound control operations for the remaining hidden running applications and the previous application in the active window.

6. The application recognition system of claim 4, wherein when none of the one or more hidden running applications is the target of user input from the input unit, the electronic device maintains the current sound control operations.

7. An application recognition method for an electronic device, wherein the electronic device comprises a sound output unit for outputting sound and stores a plurality of applications and relationships between the applications and sound control instructions, and each sound control instruction is associated with a preset sound, the method comprising:
determining whether or not at least one application is running in the electronic device;
if the at least one application is running, determining whether or not there are one or more hidden running applications, wherein each of the hidden applications is associated with an inactive window under a current active window in focus associated with a running application on a screen of the electronic device;
if there are the one or more hidden running applications, acquiring a sound control instruction associated with each of the hidden running applications; and
performing a sound control operation and controlling the sound output unit to output the preset sound every preset time period based on the sound control instruction.

8. The application recognition method of claim 7, further comprising:
when one of the at least one application receives an input signal from a user, determining that other applications are hidden.

9. The application recognition method of claim 7, wherein the sound output unit is an earphone, the method further comprising:
controlling the left channel of the earphone to output a first preset sound every first preset time period and the right channel of the earphone to output a second preset sound every second preset time period.

10. The application recognition method of claim 7, further comprising:
determining whether or not one of the one or more hidden running applications is target of user input from a user.

11. The application recognition method of claim 10, further comprising:
if one of the one or more hidden running applications is the target of user input from the user, removing the sound control operation of that application and perform sound control operations for the remaining hidden running applications and the previous application in the active window.

12. The application recognition method of claim 10, further comprising:
if none of the one or more hidden running applications is the target of user input from the user, maintaining the current sound control operations.
